(19) United States
(12) Patent Application Publication
(10) Pub. No.: US 2026/0210503 A1
(43) Pub. Date: Jul. 23, 2026

(54) LAMP WITH FUNCTIONAL INDICATOR

(71) Applicant: FEIT ELECTRIC COMPANY, INC., Pico Rivera, CA (US)

(72) Inventor: Jose MATA, Pico Rivera, CA (US)

(21) Appl. No.: 19/457,282

(22) Filed: Jan. 23, 2026

Related U.S. Application Data
(60) Provisional application No. 63/748,553, filed on Jan. 23, 2025.

(51) Int. Cl. F21K 9/235; F21K 9/232; F21K 9/238; F21V 23/06; F21Y 115/10; G09F 3/02; H05B 45/20; H05B 47/17

(52) U.S. Cl. CPC F21K 9/235; F21K 9/238; F21V 23/06; G09F 3/02; H05B 45/20; H05B 47/17; F21K 9/232; F21Y 2115/10

(57) ABSTRACT

A system comprising a lamp having a base including a related functional indicator and an enclosure as well as an associated method are provided herein. In some embodiments, the system includes a lamp including an envelope and a base secured to the lamp envelope, the lamp including at least one light source, the base comprising an insulator including a functional indicator. In some embodiments, the indicator corresponds to an operating mode of the at least one light source such that when the at least one light source is operated, it operates in accordance with the operating mode. In some embodiments, the functional indicator comprises a correlated color temperature (CCT) indicator. In some embodiments, the system comprises a corresponding indicator reference that may appear on packaging including the lamp. In some embodiments, the indicator reference may further appear on a widely available media such as a website.

### CROSS REFERENCE TO RELATED APPLICATION

This application claims priority to U.S. Provisional Ser. No. 63/748,553 , filed on Jan. 23, 2025, the entire disclosure of which is hereby incorporated by reference.

### BACKGROUND

Applicant has identified many challenges and difficulties associated with lamps and identifying a function associated with the lamps including operational modes and/or a correlated color temperature of the light emitted by lamps. Through applied effort, ingenuity, and innovation, Applicant has solved problems related to lamps and the function associated with the lamps including the correlated color temperature of the light emitted by lamps by developing solutions embodied in the present disclosure, which are described in detail below.

### BRIEF SUMMARY

Various embodiments described herein relate to lamps and identifying a function associated with the lamps including operational modes and/or a correlated color temperature of the light emitted by lamps.

In accordance with one aspect of the disclosure, a lamp is provided. In some embodiments, the lamp comprises a base comprising an insulator. In some embodiments, the insulator comprises a functional indicator. In some embodiments, the lamp comprises a lamp envelope. In some embodiments, the base is secured to the lamp envelope. In some embodiments, the lamp comprises at least one light source enclosed within a volume of the lamp defined by the base and the lamp envelope. In some embodiments, the functional indicator corresponds to an operating mode of the at least one light source such that when the at least one light source is operated, the at least one light source operates in accordance with the operating mode.

In some embodiments, the base comprises an engagement portion, wherein the engagement portion is configured to be secured to a lamp socket such that when the engagement portion is secured to the lamp socket, the functional indicator is not visible.

In some embodiments, the operating mode defines a CCT of light emitted by the at least one light source during operation, wherein the CCT of the light emitted by the at least one light source during operation is within one of a plurality of CCT ranges.

In some embodiments, the functional indicator is visible on an exterior surface of the insulator.

In accordance with another aspect of the disclosure, a system is provided. In some embodiments, the system comprises a lamp. In some embodiments, the lamp comprises a base comprising an insulator. In some embodiments, the insulator comprises a functional indicator. In some embodiments, the lamp comprises a lamp envelope. In some embodiments, the base is secured to the lamp envelope. In some embodiments, the lamp comprises at least one light source enclosed within a volume of the lamp defined by the base and the lamp envelope. In some embodiments, the functional indicator corresponds to an operating mode of the at least one light source such that when the at least one light source is operated, the at least one light source operates in accordance with the operating mode. In some embodiments, the system comprises an enclosure. In some embodiments, the lamp is enclosed within the enclosure.

In some embodiments, the enclosure comprises an indicator reference corresponding to the functional indicator.

In some embodiments, the indicator reference is disposed on an exterior surface of the enclosure.

In some embodiments, the indicator reference comprises a correlated color temperature (CCT) indicator for identifying a CCT of the light emitted by the at least one light source during operation.

In some embodiments, the CCT indicator comprises a color corresponding to the CCT of light emitted by the at least one light source during operation.

In some embodiments, the functional indicator comprises a correlated color temperature (CCT) indicator for identifying a CCT of the light emitted by the at least one light source during operation.

In some embodiments, the CCT indicator comprises a color corresponding to the CCT of light emitted by the at least one light source during operation.

In some embodiments, the enclosure comprises packaging for the lamp.

In some embodiments, the operating mode defines a CCT of light emitted by the at least one light source during operation.

In some embodiments, the CCT of the light emitted by the at least one light source during operation is within one of a plurality of CCT ranges.

In some embodiments, the plurality of CCT ranges is selected from the group consisting essentially of: a first CCT range between 2000 Kelvin (K) and 2900 K; a second CCT range between 2900 K and 3400 K; a third CCT range between 3400 K and 3900 K; a fourth CCT range between 3900 K and 4900 K; a fifth CCT range between 4900 K and 6400 K; combinations therefrom and alternatives therein.

In some embodiments, the insulator is plastic and an engagement portion of the base is metal.

In some embodiments, the functional indicator is visible on an exterior surface of the insulator.

In some embodiments, the base comprises an engagement portion. In some embodiments, the engagement portion is configured to be secured to a lamp socket such that when the engagement portion is secured to the lamp socket, the lamp socket covers the functional indicator.

In some embodiments, the lamp further comprises a controller configured to control operation of the at least one light source such that the at least one light source emits light in accordance with the operating mode.

In accordance with another aspect of the disclosure, a method is provided. In some embodiments, the method comprises identifying a functional indicator associated with a lamp. In some embodiments, the lamp comprises a base comprising an insulator. In some embodiments, the insulator comprises the functional indicator. In some embodiments, the lamp comprises a lamp envelope. In some embodiments, the base is secured to the lamp envelope. In some embodiments, the lamp comprises at least one light source enclosed within a volume of the lamp defined by the base and the lamp envelope. In some embodiments, the functional indicator corresponds to an operating mode of the at least one light source. In some embodiments, the method comprises causing the at least one light source to operate in accordance with the operating mode in response to detecting an activation trigger. In some embodiments, the method comprises causing the at least one light source to stop operating in accordance with the operating mode in response to detecting a deactivation trigger.

In some embodiments, the functional indicator comprises a correlated color temperature (CCT) indicator for identifying a CCT of the light emitted by the at least one light source during operation.

In some embodiments, the CCT indicator comprises a color corresponding to the CCT of light emitted by the at least one light source during operation.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE SEVERAL VIEWS OF THE DRAWING(S)

Having thus described certain example embodiments of the present disclosure in general terms above, non-limiting and non-exhaustive embodiments of the subject disclosure will now be described with reference to the accompanying drawings which are not necessarily drawn to scale. The components illustrated in the accompanying drawings may or may not be present in certain embodiments described herein. Some embodiments may include fewer (or more) components than those shown in the drawings. Some embodiments may include the components arranged in a different way:

FIG. 1 is a schematic view of a system in accordance with various embodiments of the present disclosure;

FIG. 2 is a partial view of a base of a lamp in accordance with various embodiments of the present disclosure;

FIG. 3 is a partial view of the lamp in accordance with various embodiments of the present disclosure;

FIG. 4 is a partial bottom view of the lamp in accordance with various embodiments of the present disclosure;

FIG. 5 illustrates a table in accordance with various embodiments of the present disclosure;

FIG. 6 is a partial view of an enclosure in accordance with various embodiments of the present disclosure; and

FIG. 7 provides a flowchart illustrating an example method in accordance with various embodiments of the present disclosure.

### DETAILED DESCRIPTION OF VARIOUS EMBODIMENTS

Various embodiments now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

Embodiments of the present disclosure are directed to a system comprising a lamp having a functional indicator and an enclosure as well as an associated method. In some examples, it may be desirable for a functional indicator to be present on a portion of a lamp that corresponds to a correlated color temperature (CCT) of light emitted by a lamp. In this way, the lamp may be configured to indicate the CCT of the light emitted by the lamp without reference to any external resources. In some examples, it may be desirable for a functional indicator present on a lamp to be visible when a lamp is not secured to a lamp socket and not visible when a lamp is secured to the lamp socket. In some examples, it may be desirable for the enclosure in which a lamp is enclosed to have an indicator reference corresponding to the CCT of the light emitted by the lamp. In this way, the CCT of the light emitted by a lamp may be determined when the lamp is enclosed in the enclosure and not visible. In some examples, it may be desirable to be able to control operation of a lamp based on a functional indicator associated with the lamp.

Thus, to address these and/or other issues, a system comprising a lamp having a functional indicator and an enclosure as well as an associated method are provided herein. For example, the system may include a lamp. The lamp may include a base comprising an insulator. In some embodiments, the insulator includes a functional indicator. In some embodiments, the lamp includes a lamp envelope. In some embodiments, the base is secured to the lamp envelope. In some embodiments, the lamp includes at least one light source enclosed within a volume of the lamp defined by the base and the lamp envelope. In some embodiments, the functional indicator corresponds to an operating mode of the at least one light source such that when the at least one light source is operated, the at least one light source operates in accordance with the operating mode. In some embodiments, the system includes an enclosure. In some embodiments, the lamp is enclosed within the enclosure.

### Example Systems and Apparatuses

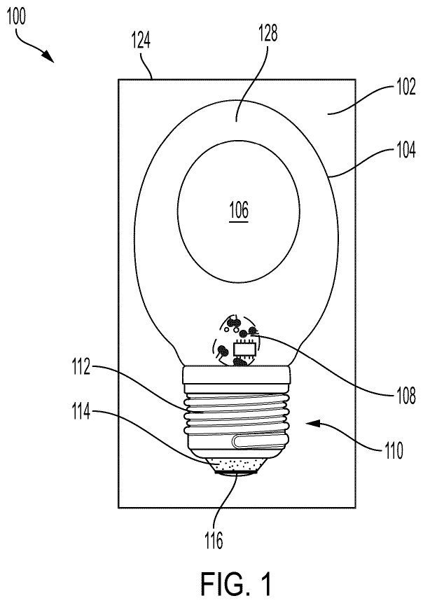

With reference to FIGS. 1-6, a system 100 and/or one or more components of the system 100 are illustrated. In some embodiments, system 100 includes a lamp 102 and/or an enclosure 124.

In some embodiments, the lamp 102 is configured to provide light to a surrounding environment. For example, the lamp 102 may be configured to provide light to a surrounding environment when the lamp 102 is secured to a lamp socket 122 located in the surrounding environment (e.g., the lamp socket 122 may be fixed to a structure in the surrounding environment). In some embodiments, the lamp 102 includes a base 110. Additionally, or alternatively, the lamp 102 includes a lamp envelope 104. Additionally, or alternatively, the lamp 102 includes at least one light source 106. Additionally, or alternatively, the lamp 102 includes a controller 108.

In some embodiments, the lamp envelope 104 is at least semi-transparent or translucent globe, bulb, or enclosing element. For example, the lamp envelope 104 may be formed of clear or frosted glass or a semi-transparent, transparent, translucent, clear and/or frosted plastic. In some embodiments, the lamp envelope 104, with the base 110, encloses a volume 128. For example, the lamp envelope 104 and the base 110 may prevent user access to the volume 128. In some embodiments, the at least one light source 106 is mounted within the volume 128. In some embodiments, a controller 108 is mounted within the volume 128.

In various embodiments, the at least one light source 106 includes one or more components configured to emit light. For example, the at least one light source 106 may include one or more light emitting diodes (LED) packages. In some embodiments, an LED package comprises one or more LED chips, electrical contacts, and optionally phosphor (e.g., to cause the LED package to emit white light and/or light associated with varying correlated color temperatures). An LED package may further comprise encapsulant to protect the one or more LED chips, wire bonds, and/or phosphor. In some embodiments, the LED packages may comprise one or more alternate current (AC) driven LEDs. In some embodiments, an LED package may further comprise one or more optical elements configured to control one or more of correlated color temperature (CCT), color rendering index (CRI), beam direction, beam profile, beam dispersion, color (“white”, red, green, blue, purple, orange, etc.), and/or the like of the light emitted by the LED package. Additionally, or alternatively, the at least one light source 106 may include one or more filaments.

In some embodiments, the at least one light source 106 is configured to be operated in accordance with an operating mode. In some embodiments, the operating mode defines a CCT of the light emitted by the at least one light source 106 during operation and/or a range of CCTs emitted by the at least one light source 106 during operation. In some embodiments, the CCT of the light emitted by the at least one light source 106 during operation is within one of a plurality of CCT ranges.

In some embodiments, the plurality of CCT ranges includes a first CCT range. In some embodiments, the first CCT range is between 2000 Kelvin (K) and 2900 K. In this regard, in some embodiments, when the light emitted by the at least one light source 106 during operation is within the first CCT range, the light corresponds to a soft white light. In some embodiments, the plurality of CCT ranges includes a second CCT range. In some embodiments, the second CCT range is between 2900 K and 3400 K. In this regard, in some embodiments, when the light emitted by the at least one light source 106 during operation is within the second CCT range, the light corresponds to a warm white light. In some embodiments, the plurality of CCT ranges includes a third CCT range. In some embodiments, the third CCT range is between 3400 K and 3900 K. In this regard, in some embodiments, when the light emitted by the at least one light source 106 during operation is within the third CCT range, the light corresponds to a bright white light. In some embodiments, the plurality of CCT ranges includes a fourth CCT range. In some embodiments, the fourth CCT range is between 3900 K and 4900 K. In this regard, in some embodiments, when the light emitted by the at least one light source 106 during operation is within the fourth CCT range, the light corresponds to a cool white light. In some embodiments, the plurality of CCT ranges includes a fifth CCT range. In some embodiments, the fifth CCT range is between 4900 K and 6400 K. In this regard, in some embodiments, when the light emitted by the at least one light source 106 during operation is within the fifth CCT range, the light corresponds to daylight.

Additionally, or alternatively, the operating mode defines a color of the light emitted by the at least one light source 106 during operation. Additionally, or alternatively, the operating mode defines a luminous flux of the light emitted by the at least one light source 106 during operation. Additionally, or alternatively, the operating mode defines a beam profile of the light emitted by the at least one light source 106 during operation. Additionally, or alternatively, the operating mode defines a beam dispersion of the light emitted by the at least one light source 106 during operation. Additionally, or alternatively, the operating mode defines a beam direction of the light emitted by the at least one light source 106 during operation. Additionally, or alternatively, the operating mode defines a CRI of the light emitted by the at least one light source 106 during operation.

In some embodiments, the controller 108 is configured to control operation of the at least one light source 106 based at least in part on an operating mode associated with the lamp 102. In this regard, for example, the controller 108 may be configured to control operation of the at least one light source 106 to cause the at least one light source 106 to emit light of a particular CCT and/or operate in a particular operating mode.

In some embodiments, the controller 108 may be embodied as one or more complex programmable logic devices (CPLDs), microprocessors, multi-core processors, co-processing entities, application-specific instruction-set processors (ASIPs), microcontrollers, and/or controllers. Further, the controller 108 may be embodied as one or more other processing devices or circuitry. The term circuitry may refer to an entirely hardware embodiment or a combination of hardware and computer program products. Thus, the controller 108 may be embodied as integrated circuits, application specific integrated circuits (ASICs), field programmable gate arrays (FPGAs), programmable logic arrays (PLAs), hardware accelerators, other circuitry, and/or the like. As will therefore be understood, the controller 108 may be configured for a particular use or configured to execute instructions stored in volatile or non-volatile media or otherwise accessible to the controller 108. As such, whether configured by hardware or computer program products, or by a combination thereof, the controller 108 is capable of performing steps or operations according to embodiments of the present disclosure when configured accordingly.

In some embodiments, the base 110 may be any standard base used with a lamp and/or other lighting device. For example, the base 110 may be an E10, E11, E12, E14, D17, E26, E39, G4, GU4, G5, GU5.3, GX5.3, GY5.3, G6.35, GY6.35, GZ6.35, GU6.5, GY8, G8.5, G9, G9.5, GZ9.5, GU10, G12, GU24, or other standard base size and/or configuration.

In some embodiments, the base 110 includes an insulator 114. In some embodiments, the insulator 114 is located between the engagement portion 112 and the electrical contact 116 on the base 110, such as illustrated in FIG. 1. For example, the insulator 114 may be connected to the engagement portion 112 on one side of the insulator 114 and connected to the electrical contact 116 on an opposite side of the insulator 114. In some embodiments, the insulator 114 is configured to insulate the electrical contact 116 during operation of the at least one light source 106.

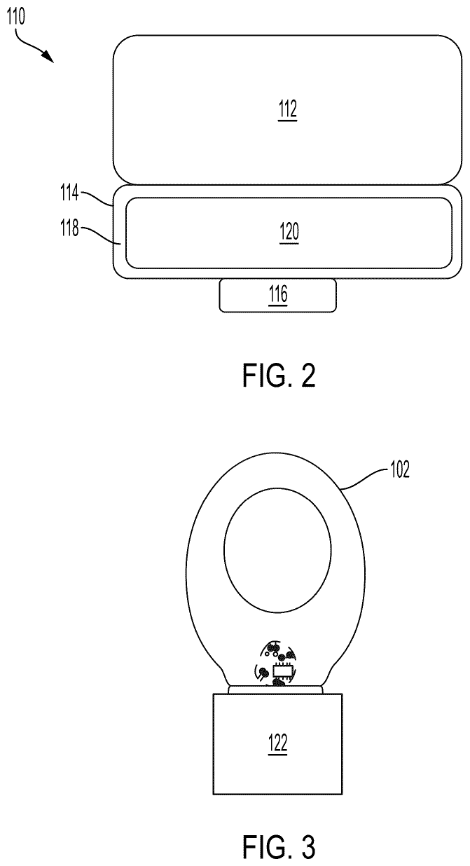

In some embodiments, the insulator 114 includes a functional indicator 120, such as illustrated in FIG. 2. In some embodiments, the functional indicator 120 is visible on an exterior surface 118 of the insulator 114. For example, the functional indicator 120 may be visible on a portion of the exterior surface 118 of the insulator 114. As another example, the functional indicator 120 may be visible on all or substantially all of the exterior surface 118 of the insulator 114.

In some embodiments, the functional indicator 120 is color, text, symbols, and/or the like that corresponds to an operating mode of the at least one light source 106. In some embodiments, the functional indicator 120 comprises a CCT indicator for identifying a CCT of the light emitted by the at least one light source 106 during operation. In this regard, in some embodiments, the CCT indicator may correspond to the CCT of the light emitted by the at least one light source 106 during operation. For example, when the CCT of the light emitted by the at least one light source 106 during operation is within the first CCT range, the CCT indicator may be color (e.g., an orange color), text, symbols, and/or the like that correspond to the light having a CCT between 2000 K and 2900 K. As another example, when the CCT of the light emitted by the at least one light source 106 during operation is within the second CCT range, the CCT indicator may be color (e.g., a yellow color), text, symbols, and/or the like that correspond to the light having a CCT between 2900 K and 3400 K. As another example, when the CCT of the light emitted by the at least one light source 106 during operation is within the third CCT range, the CCT indicator may be color (e.g., a gray color), text, symbols, and/or the like that correspond to the light having a CCT between 3400 K and 3900 K. As another example, when the CCT of the light emitted by the at least one light source 106 during operation is within the fourth CCT range, the CCT indicator may be color (e.g., a light blue color), text, symbols, and/or the like that correspond to the light having a CCT between 3900 K and 4900 K. As another example, when the CCT of the light emitted by the at least one light source 106 during operation is within the fifth CCT range, the CCT indicator may be color (e.g., a dark blue color), text, symbols, and/or the like that correspond to the light having a CCT between 4900 K and 6400 K. Said differently, for example, the functional indicator 120 may be configured such that the functional indicator 120 has a visual appearance that is indicative of the CCT of the light emitted by the at least one light source 106.

Additionally, or alternatively, the functional indicator 120 may correspond to a color of the light emitted by the at least one light source 106 during operation. Additionally, or alternatively, the functional indicator 120 may correspond to a luminous flux of the light emitted by the at least one light source 106 during operation. Additionally, or alternatively, the functional indicator 120 may correspond to a beam profile of the light emitted by the at least one light source 106 during operation. Additionally, or alternatively, the functional indicator 120 may correspond to a beam dispersion of the light emitted by the at least one light source 106 during operation. Additionally, or alternatively, the functional indicator 120 may correspond to a beam direction of the light emitted by the at least one light source 106 during operation. Additionally, or alternatively, the functional indicator 120 may correspond to a CRI of the light emitted by the at least one light source 106 during operation.

In some embodiments, the insulator 114 includes any material capable of providing insulation to the electrical contact 116. For example, the insulator 114 may include plastic, such as a molded piece of plastic. In this regard, in some embodiments, the functional indicator 120 may be embodied within the insulator 114 by including a dye in the plastic of the insulator 114 during the construction process of the insulator 114. Additionally, or alternatively, the functional indicator 120 may be disposed on the insulator 114 after the construction process of the insulator 114.

In some embodiments, the base 110 includes an engagement portion 112. In some embodiments, the engagement portion 112 is threaded. In some embodiments, the engagement portion 112 is configured to secure the lamp 102 to the lamp socket 122 via the engagement portion 112 being secured to the lamp socket 122. For example, the threads of the engagement portion 112 may be configured to mate with corresponding threads of the lamp socket 122. In this regard, in some embodiments, the lamp 102 may be secured to the lamp socket 122 by rotating the engagement portion 112 and/or the lamp 102 relative to the lamp socket 122. Additionally, or alternatively, the engagement portion 112 is configured to secure the base 110 to the lamp envelope 104. For example, the threads of the engagement portion 112 may be configured to mate with corresponding threads of the lamp envelope 104. As another example, the engagement portion 112 may be configured to secure the base 110 to the lamp envelope 104 via one or more adhesives, fixtures, and/or the like. In some embodiments, when the engagement portion 112 is secured to the lamp socket 122, the lamp socket 122 covers the functional indicator 120, such as illustrated in FIG. 3. For example, the lamp socket 122 may cover the functional indicator 120 when the engagement portion 112 is secured to the lamp socket 122 such that the functional indicator 120 is not visible.

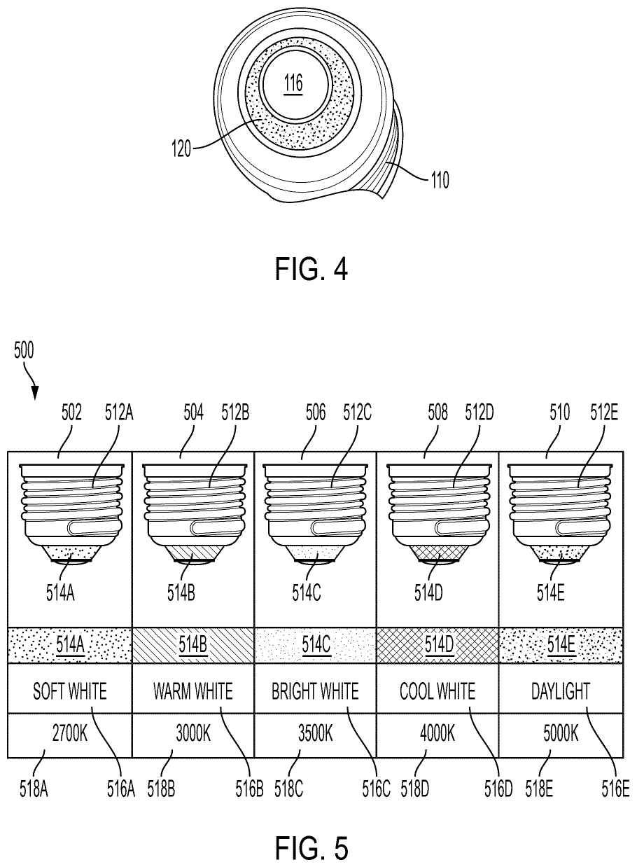

In some embodiments, the base 110 includes an electrical contact 116. In some embodiments, the electrical contact 116 is located on the bottom of the base 110, such as illustrated in FIG. 4. In some embodiments, the electrical contact 116 is configured to electrically connect the lamp 102 to the lamp socket 122. For example, the electrical contact 116 may be configured to electrically connect the controller 108 to the lamp socket 122. As another example, the electrical contact 116 may be configured to electrically connect the at least one light source 106 to the lamp socket 122. In some embodiments, the electrical contact 116 is configured to electrically connect the lamp 102 to the lamp socket 122 when the lamp 102 is secured to the lamp socket 122 (e.g., via the base 110). In this regard, in some embodiments, the electrical contact 116 may be electrically connected to a corresponding electrical contact of the lamp socket 122.

In some embodiments, the engagement portion 112 comprises metal, plastic, composite material(s), and/or the like. For example, the engagement portion 112 may include aluminum. In some embodiments, the electrical contact 116 comprises metal, composite material(s), and/or the like. In some embodiments, the electrical contact 116 and/or the engagement portion 112 are made of different materials than the insulator 114.

In some embodiments, the system 100 includes an enclosure 124. In some embodiments, the lamp 102 is enclosed within the enclosure 124. In some embodiments, the lamp 102 is enclosed within the enclosure 124 when the lamp 102 is not operating. In some embodiments, the enclosure 124 may be any shape suitable for the lamp 102 to be enclosed with the enclosure 124. For example, the enclosure 124 may be substantially cylindrical, spherical, cubical, and/or the like. As another example, at least a portion of the enclosure 124 may be shaped such that the enclosure 124 conforms to the shape of the lamp 102. In some embodiments, the enclosure 124 includes metal, plastic, composite materials, and/or the like. In some embodiments, the lamp 102 is not visible when enclosed in the enclosure 124. In some embodiments, the enclosure 124 is a packaging for the lamp 102.

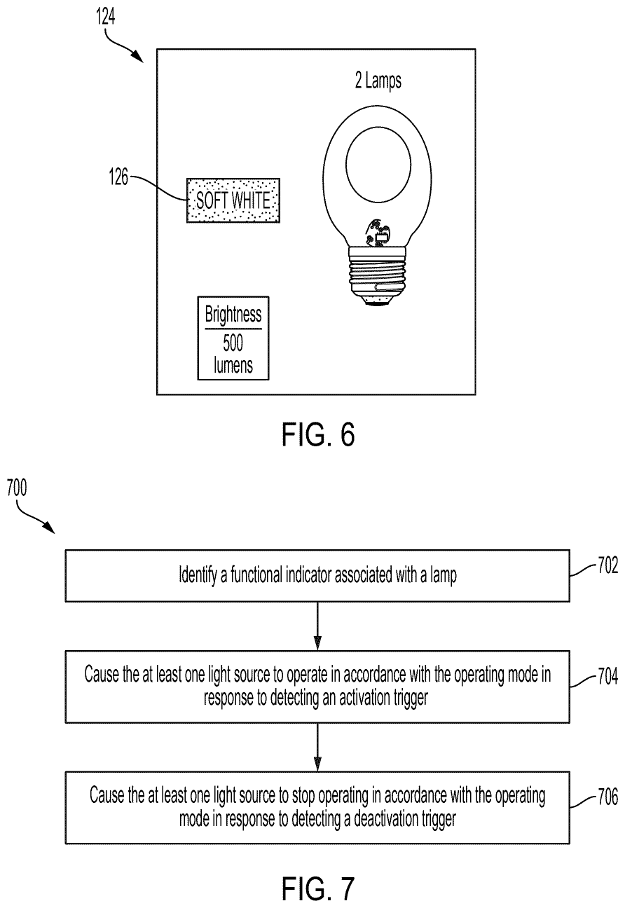

In some embodiments, the enclosure 124 includes an indicator reference 126, such as illustrated in FIG. 6. In some embodiments, the indicator reference 126 corresponds to the functional indicator 120. In this regard, in some embodiments, the indicator reference 126 is color, text, symbols, and/or the like that corresponds to an operating mode the at least one light source 106. In some embodiments, the indicator reference 126 comprises a CCT indicator for identifying a CCT of the light emitted by the at least one light source 106 during operation. In this regard, in some embodiments, the operating mode of the lamp 102 (e.g., CCT of light emitted by the lamp 102) may be determined even when the lamp 102 is enclosed within the enclosure 124 and not visible. In some embodiments, the indicator reference 126 may be displayed on a graphical user interface. In this regard, for example, the indicator reference 126 may be displayed on a webpage. Additionally, or alternatively, the indicator reference 126 may be displayed on printed material. In this regard, for example, the indicator reference 126 may be displayed in a catalog.

FIG. 5 illustrates a table 500 in which various example representations and/or descriptions of a CCT indicator are provided. In some embodiments, the table 500 includes a first column 502 that includes one or more representations and/or descriptions that are representative of one or more components of the lamp 102 and/or a CCT of the light emitted by the lamp 102 during operation. In this regard, in some embodiments, the first column 502 includes a first base representation 512A that is representative of the base 110. Additionally, or alternatively, the first column 502 includes one or more first CCT indicator representations 514A (e.g., a red color) representative of a CCT indicator when the at least one light source 106 is within the first CCT range (e.g., 2000 K and 2900 K) during operation. Additionally, or alternatively, the first column 502 includes a first CCT text description 516A (e.g., soft white) that describes a CCT of light emitted by the at least one light source 106 when the at least one light source 106 is within the first CCT range (e.g., 2000 K and 2900 K) during operation. Additionally, or alternatively, the first column 502 includes a first CCT numerical description 518A (e.g., 2700 K) that describes a CCT of light emitted by the at least one light source 106 when the at least one light source 106 is within the first CCT range (e.g., 2000 K and 2900 K) during operation.

In some embodiments, the table 500 includes a second column 504 that includes one or more representations and/or descriptions that are representative of one or more components of the lamp 102 and/or a CCT of the light emitted by the lamp 102 during operation. In this regard, in some embodiments, the second column 504 includes a second base representation 512B that is representative of the base 110. Additionally, or alternatively, the second column 504 includes one or more second CCT indicator representations 514B (e.g., a yellow color) representative of a CCT indicator when the at least one light source 106 is within the second CCT range (e.g., 2900 K and 3400 K) during operation. Additionally, or alternatively, the second column 504 includes a second CCT text description 516B (e.g., warm white) that describes a CCT of light emitted by the at least one light source 106 when the at least one light source 106 is within the second CCT range (e.g., 2900 K and 3400 K) during operation. Additionally, or alternatively, the second column 504 includes a second CCT numerical description 518B (e.g., 3000 K) that describes a CCT of light emitted by the at least one light source 106 when the at least one light source 106 is within the second CCT range (e.g., 2900 K and 3400 K) during operation.

In some embodiments, the table 500 includes a third column 506 that includes one or more representations and/or descriptions that are representative of one or more components of the lamp 102 and/or a CCT of the light emitted by the lamp 102 during operation. In this regard, in some embodiments, the third column 506 includes a third base representation 512C that is representative of the base 110. Additionally, or alternatively, the third column 506 includes one or more third CCT indicator representations 514C (e.g., a gray color) representative of a CCT indicator when the at least one light source 106 is within the third CCT range (e.g., 3400 K and 3900 K) during operation. Additionally, or alternatively, the third column 506 includes a third CCT text description 516C (e.g., bright white) that describes a CCT of light emitted by the at least one light source 106 when the at least one light source 106 is within the third CCT range (e.g., 3400 K and 3900 K) during operation. Additionally, or alternatively, the third column 506 includes a third CCT numerical description 518C (e.g., 3500 K) that describes a CCT of light emitted by the at least one light source 106 when the at least one light source 106 is within the third CCT range (e.g., 3400 K and 3900 K) during operation.

In some embodiments, the table 500 includes a fourth column 508 that includes one or more representations and/or descriptions that are representative of one or more components of the lamp 102 and/or a CCT of the light emitted by the lamp 102 during operation. In this regard, in some embodiments, the fourth column 508 includes a fourth base representation 512D that is representative of the base 110. Additionally, or alternatively, the fourth column 508 includes one or more fourth CCT indicator representations 514D (e.g., a light blue color) representative of a CCT indicator when the at least one light source 106 is within the fourth CCT range (e.g., 3900 K and 4900 K) during operation. Additionally, or alternatively, the fourth column 508 includes a fourth CCT text description 516D (e.g., cool white) that describes a CCT of light emitted by the at least one light source 106 when the at least one light source 106 is within the fourth CCT range (e.g., 3900 K and 4900 K) during operation. Additionally, or alternatively, the fourth column 508 includes a fourth CCT numerical description 518D (e.g., 4000 K) that describes a CCT of light emitted by the at least one light source 106 when the at least one light source 106 is within the fourth CCT range (e.g., 3900 K and 4900 K) during operation.

In some embodiments, the table 500 includes a fifth column 510 that includes one or more representations and/or descriptions that are representative of one or more components of the lamp 102 and/or a CCT of the light emitted by the lamp 102 during operation. In this regard, in some embodiments, the fifth column 510 includes a fifth base representation 512E that is representative of the base 110. Additionally, or alternatively, the fifth column 510 includes one or more fifth CCT indicator representations 514E (e.g., a dark blue color) representative of a CCT indicator when the at least one light source 106 is within the fifth CCT range (e.g., 4900 K and 6400 K) during operation. Additionally, or alternatively, the fifth column 510 includes a fifth CCT text description 516E (e.g., daylight) that describes a CCT of light emitted by the at least one light source 106 when the at least one light source 106 is within the fifth CCT range (e.g., 4900 K and 6400 K) during operation. Additionally, or alternatively, the fifth column 510 includes a fifth CCT numerical description 518E (e.g., 5000 K) that describes a CCT of light emitted by the at least one light source 106 when the at least one light source 106 is within the fifth CCT range (e.g., 4900 K and 6400 K) during operation.

In some embodiments, the table 500 and/or a portion of the table 500 may be displayed on the enclosure 124. For example, the first column 502 may be displayed on the enclosure 124. As another example, the fifth CCT text description 516E (e.g., daylight) may be displayed on the enclosure 124. In this regard, in some embodiments, the table 500 and/or a portion of the table 500 may be displayed on the packaging that includes the lamp 102.

In some embodiments, the table 500 and/or a portion of the table 500 may be displayed on a graphical user interface. For example, the first column 502 may be displayed on a graphical user interface. As another example, the fifth CCT text description 516E (e.g., daylight) may be displayed on a graphical user interface. In this regard, in some embodiments, the table 500 and/or a portion of the table 500 may be displayed on a webpage. Additionally, or alternatively, the table 500 and/or a portion of the table 500 may be displayed on printed material. For example, the first column 502 may be displayed on printed material. As another example, the fifth CCT text description 516E (e.g., daylight) may be displayed on printed material. In this regard, in some embodiments, the table 500 and/or a portion of the table 500 may be displayed in a catalog.

### Example Methods

FIG. 7 is a flowchart broadly illustrating an example method 700 that is performed to operate a lamp in accordance with one or more embodiments of the present disclosure. In some embodiments, the method 700 is performed using one or more components of the system 100. For example, the method 700 may be performed using the lamp 102 and/or the controller 108 of the lamp 102.

As shown in block 702, the method 700 includes identifying a functional indicator 120 associated with the lamp 102. In some embodiments, identifying the functional indicator 120 associated with the lamp 102 may include determining the functional indicator 120 of the lamp 102 (e.g., using a controller 108 of the lamp 102). In some embodiments, identifying the functional indicator 120 associated with the lamp 102 may include receiving an indication of the functional indicator 120 of the lamp (e.g., using the controller 108 of the lamp 102). For example, an indication of the functional indicator 120 of the lamp 102 may be received by the controller 108 of the lamp 102 from one or more external and/or remote computing devices.

In some embodiments, the lamp includes a base 110 comprising an insulator 114. In some embodiments, the insulator 114 includes the functional indicator 120. In some embodiments, the lamp includes a lamp envelope 104. In some embodiments, the base 110 is secured to the lamp envelope 104. In some embodiments, at least one light source 106 is enclosed within a volume 128 of the lamp 102 defined by the base 110 and the lamp envelope 104. In some embodiments, the functional indicator 120 corresponds to an operating mode of the at least one light source 106.

As shown in block 704, the method 700 includes causing the at least one light source 106 to operate in accordance with the operating mode in response to detecting an activation trigger. In some embodiments, the operating mode defines a CCT of the light emitted by the at least one light source 106 during operation.

Additionally, or alternatively, the operating mode defines a color of the light emitted by the at least one light source 106 during operation. Additionally, or alternatively, the operating mode defines a luminous flux of the light emitted by the at least one light source 106 during operation. Additionally, or alternatively, the operating mode defines a beam profile of the light emitted by the at least one light source 106 during operation. Additionally, or alternatively, the operating mode defines a beam dispersion of the light emitted by the at least one light source 106 during operation. Additionally, or alternatively, the operating mode defines a beam direction of the light emitted by the at least one light source 106 during operation. Additionally, or alternatively, the operating mode defines a CRI of the light emitted by the at least one light source 106 during operation.

In some embodiments, the activation trigger is one or more triggers that may be detected (e.g., by the controller 108 of the lamp 102). For example, the activation trigger may include actuation of a switch associated with the lamp 102 (e.g., actuation to turn the lamp on, such as when a time period is starting). As another example, the activation trigger may be a signal that is transmitted by a timer associated with the lamp 102 (e.g., a timer that sends a signal when the lamp should turn on). As another example, the activation trigger may include detection of motion in proximity of the lamp 102 (e.g., a motion detecting device that sends a signal when the lamp should turn on).

As shown in block 706, the method 700 includes causing the at least one light source to stop operating in accordance with the operating mode in response to detecting a deactivation trigger. In some embodiments, the operating mode defines a CCT of the light emitted by the at least one light source 106 during operation.

Additionally, or alternatively, the operating mode defines a color of the light emitted by the at least one light source 106 during operation. Additionally, or alternatively, the operating mode defines a luminous flux of the light emitted by the at least one light source 106 during operation. Additionally, or alternatively, the operating mode defines a beam profile of the light emitted by the at least one light source 106 during operation. Additionally, or alternatively, the operating mode defines a beam dispersion of the light emitted by the at least one light source 106 during operation. Additionally, or alternatively, the operating mode defines a beam direction of the light emitted by the at least one light source 106 during operation. Additionally, or alternatively, the operating mode defines a CRI of the light emitted by the at least one light source 106 during operation.

In some embodiments, the deactivation trigger is one or more triggers that may be detected (e.g., by the controller 108 of the lamp 102). For example, the deactivation trigger may include actuation of a switch associated with the lamp 102 (e.g., actuation to turn the lamp off). As another example, the deactivation trigger may be a signal that is transmitted by a timer associated with the lamp 102 (e.g., a timer that sends a signal when the lamp should turn off, such as after a time period has elapsed). As another example, the deactivation trigger may include an elapse of time since motion was detected in proximity of the lamp 102 (e.g., a motion detecting device that sends a signal when the lamp should turn off).

### CONCLUSION

Many modifications and other embodiments of the disclosure set forth herein will come to mind to one skilled in the art to which the disclosure pertains having the benefit of the teachings presented in the foregoing descriptions and the associated drawings. Therefore, it is to be understood that the disclosure is not to be limited to the specific embodiments disclosed and appended claims. Although specific terms are employed herein, they are used in a generic and descriptive sense only and not for purposes of limitation.

1. A lamp comprising:
a base comprising an insulator, wherein the insulator comprises a functional indicator;
a lamp envelope, wherein the base is secured to the lamp envelope; and
at least one light source enclosed within a volume of the lamp defined by the base and the lamp envelope,
wherein the functional indicator corresponds to an operating mode of the at least one light source such that when the at least one light source is operated, the at least one light source operates in accordance with the operating mode.

2. The lamp of claim 1, wherein the base comprises an engagement portion, wherein the engagement portion is configured to be secured to a lamp socket such that when the engagement portion is secured to the lamp socket, the functional indicator is not visible.

3. The lamp of claim 1, wherein the operating mode defines a CCT of light emitted by the at least one light source during operation, wherein the CCT of the light emitted by the at least one light source during operation is within one of a plurality of CCT ranges.

4. The lamp of claim 1, wherein the functional indicator is visible on an exterior surface of the insulator.

5. A system comprising:
a lamp, wherein the lamp comprises:
a base comprising an insulator, wherein the insulator comprises a functional indicator;
a lamp envelope, wherein the base is secured to the lamp envelope; and
at least one light source enclosed within a volume of the lamp defined by the base and the lamp envelope,
wherein the functional indicator corresponds to an operating mode of the at least one light source such that when the at least one light source is operated, the at least one light source operates in accordance with the operating mode; and
an enclosure, wherein the lamp is enclosed within the enclosure.

6. The system of claim 5, wherein the enclosure comprises an indicator reference corresponding to the functional indicator.

7. The system of claim 6, wherein the indicator reference is disposed on an exterior surface of the enclosure.

8. The system of claim 6, wherein the indicator reference comprises a correlated color temperature (CCT) indicator for identifying a CCT of the light emitted by the at least one light source during operation.

9. The system of claim 8, wherein the CCT indicator comprises a color corresponding to the CCT of light emitted by the at least one light source during operation.

10. The system of claim 5, wherein the functional indicator comprises a correlated color temperature (CCT) indicator for identifying a CCT of the light emitted by the at least one light source during operation.

11. The system of claim 10, wherein the CCT indicator comprises a color corresponding to the CCT of light emitted by the at least one light source during operation.

12. The system of claim 5, wherein the enclosure comprises packaging for the lamp.

13. The system of claim 5, wherein the operating mode defines a CCT of light emitted by the at least one light source during operation, wherein the CCT of the light emitted by the at least one light source during operation is within one of a plurality of CCT ranges.

14. The system of claim 13, wherein the plurality of CCT ranges is selected from the group consisting essentially of: a first CCT range between 2000 Kelvin (K) and 2900 K; a second CCT range between 2900 K and 3400 K; a third CCT range between 3400 K and 3900 K; a fourth CCT range between 3900 K and 4900 K; a fifth CCT range between 4900 K and 6400 K; combinations therefrom and alternatives therein.

15. The system of claim 5, wherein the insulator is plastic and an engagement portion of the base is metal.

16. The system of claim 5, wherein the functional indicator is visible on an exterior surface of the insulator.

17. The system of claim 5, wherein the base comprises an engagement portion, wherein the engagement portion is configured to be secured to a lamp socket such that when the engagement portion is secured to the lamp socket, the lamp socket covers the functional indicator.

18. The system of claim 5, wherein the lamp further comprises a controller configured to control operation of the at least one light source such that the at least one light source emits light in accordance with the operating mode.

19. A method comprising:
identifying a functional indicator associated with a lamp, wherein the lamp comprises:
a base comprising an insulator, wherein the insulator comprises the functional indicator;
a lamp envelope, wherein the base is secured to the lamp envelope; and
at least one light source enclosed within a volume of the lamp defined by the base and the lamp envelope,
wherein the functional indicator corresponds to an operating mode of the at least one light source;
causing the at least one light source to operate in accordance with the operating mode in response to detecting an activation trigger; and
causing the at least one light source to stop operating in accordance with the operating mode in response to detecting a deactivation trigger.

20. The method of claim 19, wherein the functional indicator comprises a correlated color temperature (CCT) indicator for identifying a CCT of the light emitted by the at least one light source during operation, wherein the CCT indicator comprises a color corresponding to the CCT of light emitted by the at least one light source during operation.
